(19) United States
(12) Patent Application Publication
(10) Pub. No.: US 2005/0172959 A1
(43) Pub. Date: Aug. 11, 2005

(54) Communication apparatus, method and system for a self-contained breathing apparatus

(76) Inventor: Robby Gordon Williams, Calgary (CA)

Correspondence Address: KOLISCH HARTWELL, P.C., 520 S.W. YAMHILL STREET, SUITE 200, PORTLAND, OR, 97204, US

(21) Appl. No.: 10/517,218

(22) PCT Filed: May 27, 2003
(86) PCT No.: PCT/CA03/00796

Related U.S. Application Data
(60) Provisional application No. 60/385,580, filed on Jun. 5, 2002.

(51) Int. Cl. A62B 18/08

(52) U.S. Cl. 128/201.19

(57) ABSTRACT

A method of facilitating communicaons for a wearer of a mask, such as a firefighter's breathing apparatus, involves receiving a removable transmitter apparatus in a receptacle in the mask, to permit the transmitter apparatus to receive acoustic utterances made by the wearer of the mask and to transmit electromagnetic radiation representing the utterances for reception by a receiver. The receiver receives the electromagnetic radiation and broadcasts an audible reproduction of the acoustic utterances. The receiver may be supported by a wearer of the mask so that listeners in the vicinity of the wearer can hear the utterances. A plurality of wearers of masks may each have the apparatus described above to create a mobile public address system in which the utterances of a plurality of wearers may be broadcast from each wearer to other people in the vicinity of the wearers.

### BACKGROUND OF THE INVENTION

1. Field of Invention

This invention relates to communications systems, and more particularly, to methods and apparatus for communicating while wearing a self-contained breathing apparatus.

2. Description of Related Art

Communication between fire fighters wearing a self-contained breathing apparatus, such as a face mask, for example, is extremely difficult under the best conditions and almost impossible in most fire situations. Fire fighters must yell through their masks or use elaborate hand signals, or in some cases, may even remove their mask, just to be able to talk to each other. Since fire fighting often requires split-second decision making, often with serious consequences at stake, there is a need for rapid and coherent communication to avoid exposing fire fighters and the public to undue risk.

Existing mechanisms typically employ a microphone which is “push-to-talk” activated and coupled via an interface box and corded )ink to a speaker placed in proximity to a wearer's ear, thereby providing a walkie-talkie type arrangement. A wearer of the self-contained breathing apparatus must push a button to talk into the microphone, which requires that the wearer can only have one hand free while talking into the apparatus. Moreover, a voice signal picked up by the microphone is usually amplified to be presented to a speaker of another user, which often picks up interference in the form of ambient noise encountered in most fire situations. This interference can cause false triggering of voice detection circuitry. In addition, the geometry of the cavity inside the self-contained breathing apparatus enhances low frequencies, making the wearer's voice virtually unintelligible when transmitted to a remote user. The cord connecting the microphone and speaker to the interface box can often frustrate a user as it can become entangled in other fire fighting equipment or the user's clothes, or it may loosen and become detached, preventing communication between fire fighters. In short, the cord can be a safety hazard. In addition, the absence of communication with a fire fighter may indicate that the fire fighter is in a dangerous situation and that the other members of the crew should locate and help the person in need, possibly in a smoke-filled room with zero visibility.

### SUMMARY OF THE INVENTION

In accordance with one aspect of the invention, there is provided a transmitter apparatus. The transmitter apparatus includes a microphone operable to produce electrical signals representing acoustic utterances, a transmitter circuit in communication with the microphone and operable to transmit electromagnetic radiation representing the acoustic utterances for reception by a receiver, a housing having first and second opposite end portions and a retention portion between the first and second opposite end portions, the retention portion being operable to co-operate with a receptacle on a breathing apparatus to facilitate installation into the breathing apparatus and removal of the transmitter apparatus from the breathing apparatus.

The transmitter apparatus may also include a compensator for compensating for distortions made to the acoustic utterances. The compensator may filter the utterances made by the wearer. The compensator may include a compensator circuit for electrically compensating for the distortions.

The microphone of the transmitter apparatus may be on one of the first and second opposite end portions of the housing.

The transmitter apparatus may further include power terminals for cooperating with a power source to permit the power source to provide energy for powering the transmitter. The power terminals may be inside the housing. The apparatus may include a charging port for receiving energy supplied externally to the housing and for providing the energy to the power terminals. The charging port may include a charging socket on an end of the housing and opposite the end on which the microphone is located.

The retention portion of the transmitter apparatus may be curved and may be concave. The retention portion may have a leading edge and a trailing edge, the leading edge being thicker than the trailing edge. The retention portion may also have a wedge-shaped cross section.

The housing of the transmitter apparatus may be modular, and the breathing apparatus may have a receptacle for receiving and holding the housing therein.

In accordance with another aspect of the invention, there is provided a system including a transmitter apparatus as described above and further including a receiver operable to be supported by a wearer of the breathing apparatus and operable to audibly broadcast a reproduction of acoustic utterances in response to receipt of the electromagnetic radiation at the receiver. In such a system, the receiver may be operable to produce signals representing the acoustic utterances in response to the electromagnetic radiation and the system may further include a repeater operable to re-transmit a representation of the utterances to a remote receiver.

In accordance with another aspect of the invention, there is provided a transmitter apparatus which includes a device for producing electrical signals representing acoustic utterances, a device in communication with the device for producing, for transmitting electromagnetic radiation representing the acoustic utterances for reception by a receiver, a device for housing the device for producing and the device for transmitting, and a device for retaining the device for housing in a receptacle on a breathing apparatus to facilitate installation of the transmitter apparatus into the breathing apparatus and to facilitate removal of the transmitter apparatus from the breathing apparatus.

In accordance with another aspect of the invention, there is provided a method of facilitating communications for a wearer of a breathing apparatus. The method includes transmitting from a transmitter on the breathing apparatus electromagnetic radiation representing acoustic utterances made by the wearer of the breathing apparatus for reception by a receiver supported by the wearer, and audibly broadcasting a reproduction of the acoustic utterances in response to receipt of the electromagnetic radiation at the receiver.

Transmitting may include transmitting from a transmitter mounted in the breathing apparatus. Transmitting may also include transmitting from a removable transmitter mounted in the breathing apparatus.

The method may further include producing signals in response to the electromagnetic radiation and transmitting the signals to a repeater for re-transmission to a remote receiver. The method may further include producing electrical signals in response to the electromagnetic radiation, the electrical signals representing the acoustic utterances, and the method may include filtering the signals to correct for distortions.

In accordance with another aspect of the invention, there is provided an apparatus facilitating communications for a wearer of a breathing apparatus. The apparatus includes a device on the breathing apparatus for transmitting electromagnetic radiation representirig acoustic utterances made by the wearer of the breathing apparatus for reception by a receiver supported by the wearer, and a device for audibly broadcasting a reproduction of the acoustic utterances in response to receipt of the electromagnetic radiation at the receiver.

In accordance with another aspect of the invention, there is provided a method of facilitating communications between wearers of a breathing apparatus and a listener within a range of at least one of the wearers of the breathing apparatus. The method includes transmitting from a transmitter on the breathing apparatus electromagnetic radiation representing acoustic utterances made by at least one wearer of a breathing apparatus, for reception by a plurality of receivers supported by respective wearers within a range, and audibly broadcasting a reproduction of the acoustic utterances in response to receipt of the electromagnetic radiation at at least one of the receivers.

In accordance with another aspect of the invention, there is provided a system for facilitating communications between wearers of a breathing apparatus and a listener within a range of at least one of the wearers of the breathing apparatus. The system includes a device on the breathing apparatus for transmitting electromagnetic radiation representing acoustic utterances made by at least one of the wearers of the breathing apparatus, for reception by a plurality of receivers supported by respective wearers within the range. The system further includes a device for audibly broadcasting a reproduction of the acoustic utterances in response to receipt of the electromagnetic radiation at at least one of the receivers.

In accordance with another aspect of the invention, there is provided a system for facilitating communications between wearers of a breathing apparatus and a listener within a range of at least one of the wearers of the breathing apparatus. The system includes a device for transmitting from a transmitter on the breathing apparatus electromagnetic radiation representing acoustic utterances made by at least one of the wearers of the breathing apparatus, for reception by a plurality of receivers supported by respective wearers within the range. The system also includes a device for audibly broadcasting a reproduction of the acoustic utterances in response to receipt of the electromagnetic radiation at at least one of the receivers.

In accordance with another aspect of the invention, there is provided a system for facilitating communications between wearers of a breathing apparatus and a listener within a range of at least one of the wearers of the breathing apparatus. The system includes a plurality of transmitters held in respective receptacles in respective breathing apparatuses for transmitting electromagnetic radiation representing acoustic utterances made by at least one of the wearers, and a plurality of receivers supported by respective wearers, for receiving electromagnetic radiation representing acoustic utterances from at least one of the transmitters. The system also includes a plurality of speakers supported by the respective wearers, the speakers being controlled by respective receivers to audibly broadcast a reproduction of the acoustic utterances represented by the electromagnetic radiation transmitted by at least one of the transmitters.

In accordance with one aspect of the invention, there is provided a method of communicating the occurrence of an event indicated by a pre-defined audio signal. The method involves detecting a first pre-defined audio signal, and transmitting a pre-defined radio frequency signal in response to detection of the first pre-defined audio signal.

The method may involve wearing a detector capable of detecting the first pre-defined audio signal and wearing a transmitter capable of transmitting the pre-defined radio frequency signal.

The method may involve transmitting a message indicative of the occurrence of the event. Transmitting may further involve or alternatively involve transmitting a homing signal.

The method may involve detecting the event and producing the first pre-defined audio signal in response to detection of the event.

The method may involve wearing a detector operable to detect the event.

The method may involve producing a second pre-defined audio signal in response to receiving the first pre-defined radio frequency signal and producing the second pre-defined audio signal may involve producing a synthesized voice message.

In accordance with another aspect of the invention, there is provided an apparatus for communicating the occurrence of an event indicated by a pre-defined audio signal. The apparatus may involve provisions for detecting a first pre-defined audio signal and provisions for transmitting a pre-defined radio frequency signal in response to detection of the first pre-defined audio signal.

The apparatus may include provisions to facilitate wearing the provisions for detecting the first pre-defined audio signal and the provisions for transmitting.

The provisions for transmitting may be operable to transmit a message indicative of the event and/or may be operable to transmit a homing signal.

In accordance with another aspect of the invention, there is provided a system involving the apparatus above and further involving provisions for detecting the event and provisions for producing the first pre-defined audio signal in response to detection of the event The system may involve provisions facilitating wearing of the provisions for detecting the event.

In accordance with another aspect of the invention, there is provided a system involving the apparatus above and further involving provisions for producing a second pre-defined audio signal in response to receiving the first pre-defined radio frequency signal. The provisions for producing the second pre-defined audio signal may involve provisions for producing a synthesized voice message.

In accordance with another aspect of the invention, there is provided an apparatus for communicating the occurrence of an event indicated by a pre-defined audio signal. The apparatus includes a detector operable to detect a first pre-defined audio signal and a transmitter operable to transmit a pre-defined radio frequency signal in response to detection of the first pre-defined audio signal.

The apparatus may include a strap connected to the detector and the transmitter to facilitate wearing the detector and the transmitter on a person.

The transmitter may be operable to transmit a message indicative of the event and/or transmit a homing signal.

In accordance with another aspect of the invention, there is provided a system involving the apparatus above and further involving an event detector and an audio signal generator in communication with the event detector for generating the first pre-defined audio signal in response to detection of the event.

A strap may be connected to the event detector and the audio signal generator to facilitate wearing the event detector and the audio signal generator on a person.

In accordance with another aspect of the invention, there is provided a system involving the apparatus above and further involving a second audio signal generator for generating a second audio signal in response to receipt of the first pre-defined radio signal. The second audio signal generator may include a voice synthesizer for producing a voice synthesized message.

In accordance with another aspect of the invention, there is provided a method of facilitating communications for a wearer of a mask. The method may include receiving a removable transmitter apparatus in a receptacle in the mask, to permit the transmitter apparatus to receive utterances made by the wearer of the mask and to transmit electromagnetic radiation representing the utterances for reception by a receiver. The method may further include frictionally engaging the removable transmitter apparatus in the receptacle to hold the removable transmitter apparatus therein.

Receiving the transmitter apparatus may include receiving the transmitter apparatus in the receptacle on a user-facing side of the mask. Receiving may also include receiving the transmitter apparatus between a breathing valve and a chin seal defining the receptacle in the mask. A portion of the chin seal may be received between opposite end portions of the transmitter apparatus. Receiving may also indude receiving a portion of the chin seal in a concave portion of the transmitter and/or receiving a portion of the chin seal adjacent a curved portion of the transmitter.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a fragmented side view of a breathing apparatus fitted with a transmitter apparatus according to a first embodiment of the invention;

FIG. 2 is a perspective view of the transmitter apparatus shown in FIG. 1;

FIG. 3 is a fragmented side view of a breathing apparatus incorporating the transmitter apparatus shown in FIG. 2;

FIG. 4 is a block diagram of a transmitter circuit contained within the transmitter apparatus shown in FIG. 2;

FIG. 5A is a block diagram of a receiver circuit for receiving transmissions produced by the transmitter apparatus of FIG. 2;

FIG. 5B is a flowchart of routines executed by a processor circuit shown in FIG. 5A;

FIG. 6A is a perspective view of a prior art “man down” prior art sensing unit;

FIG. 6B is a front view of a receiver housing for housing the receiver shown in FIG. 5A;

FIG. 7 is a schematic representation of a system in which a plurality of the transmitters shown in FIG. 2 and the receivers shown in FIG. 6 are employed; and

FIG. 8 is a block diagram of a repeater operable to be used with the transmitter shown in FIG. 2.

### DETAILED DESCRIPTION

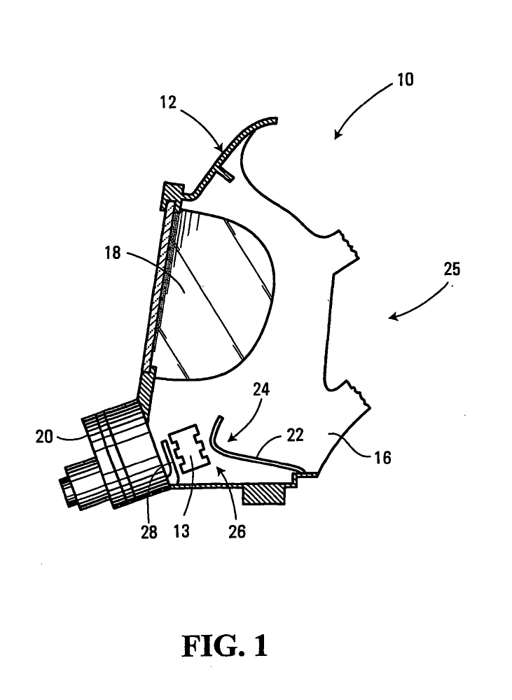

Referring to FIG. 1, an apparatus according to a first embodiment of the invention is shown generally at 10. The apparatus includes a self-contained breathing apparatus shown generally at 12 and a transmitter apparatus 13 which is received within the self-contained breathing apparatus 12. In this embodiment, the self-contained breathing apparatus 12 is in the form of a fire fighter's mask having a rubber face shield 16, a lens 18, a breathing valve 20 and a rubber chin seat 22. The rubber chin seal 22 is flexible and has a curved portion shown generally at 24 that fits relatively snugly on the chin of a wearer. A receptacle 26 is formed on a user-facing side 25 of the breathing apparatus between the chin seal 22 and a flexible tab 28 protruding into the mask from the breathing valve 20. The transmitter apparatus 13 is a removable device that is received in the receptacle 26 in the breathing apparatus 12 to permit the transmitter apparatus 13 to receive acoustic utterances made by the wearer of the mask and to transmit electromagnetic radiation representing the acoustic utterances for reception by a receiver.

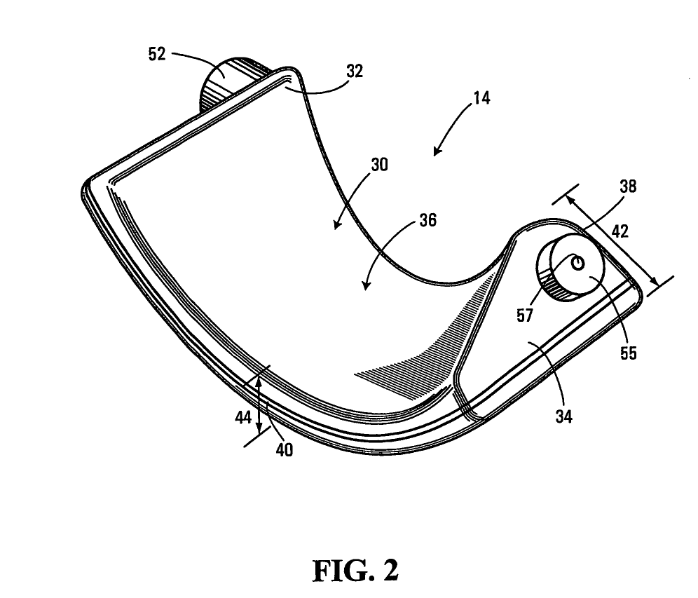

Referring to FIG. 2, a transmitter apparatus 14, according to a second embodiment of the invention, has a housing shown generally at 30 having first and second opposite ends 32 and 34 with a retention portion shown generally at 36 therebetween.

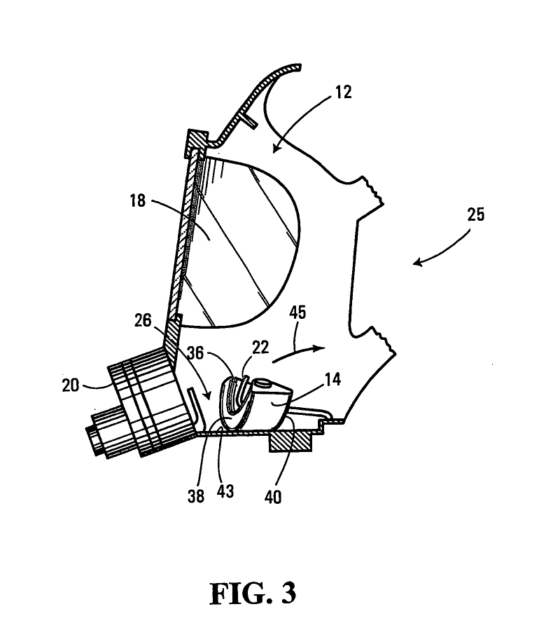

Referring to FIG. 3, the retention portion 36 is operable to co-operate with the receptacle 26 of the breathing apparatus 12 to facilitate installation and removal of the transmitter apparatus 14. In the embodiment shown in FIGS. 2 and 3, the retention portion 36 is concavely curved and has a leading edge 38 and a trailing edge 40, the leading edge being thicker as shown by dimension arrow 42, than the trailing edge as shown by dimension arrow 44. Referring to FIG. 3, the leading edge 38 faces outwardly, away from the wearer and the trailing edge 40 faces inwardly, while the chin seal 22 is received on the retention portion 36 and between the opposite end portions 32 and 34 of the transmitter apparatus as shown in FIG. 2, and thus prevents side-to-side movement of the transmitter apparatus 14 in the breathing apparatus 12. A wedge effect and friction fit of the housing 30 shown in FIG. 2, between a rubber lower portion 43 of the mask and the chin seal 22 prevent vertical movement of the transmitter apparatus. Thus, the transmitter apparatus 14 is relatively snugly held within the breathing apparatus 12 but is easily removed by simply pulling the chin seal 22 back in the direction shown by arrow 45 and simply removing the transmitter apparatus from the receptacle 26. Installation of the transmitter apparatus is achieved by following the above steps in reverse order. Thus, it will be appreciated that the transmitter apparatus 14 is easily installed and easily removed from the breathing apparatus.

Easy removal and installation of the transmitter apparatus 14 in the manner described is advantageous because it allows the transmitter apparatus to be removed from the mask after use and conveniently disinfected and electrically charged for subsequent use. Furthermore, it requires no modifications to existing popular breathing apparatuses. Thus, the device is a convenient retrofit item. In addition, since the transmitter apparatus is installed in the breathing apparatus, the breathing apparatus itself blocks ambient noise outside the breathing apparatus from reaching the transmitter apparatus and thus background noise in transmissions made by the transmitter apparatus is relatively quiet.

The transmitter apparatus 14 may be stored in a charger (not shown), for example, and as a fire crew suits up to attend a fire, a fire fighter may grasp the breathing apparatus 12 in one hand and grasp the transmitter apparatus 14 In the other hand and while walking, or while stationary, simply Insert the removable transmitter apparatus in the receptacle 26 in the breathing apparatus in the position shown in FIG. 3. Similarly, when the wearer Is finished with the apparatus, the transmitter apparatus 14 may be easily removed and replaced back into the charger. To facilitate this use of the transmitter apparatus 14, it is desirable that a plurality of modular transmitting units having the general shape shown in FIG. 2, for example, be used, so that transmitter apparatus are interchangeable between breathing apparatus of a given type, thus eliminating any requirement for a particular transmitter to be matched with a particular mask.

Transmitter Apparatus 14

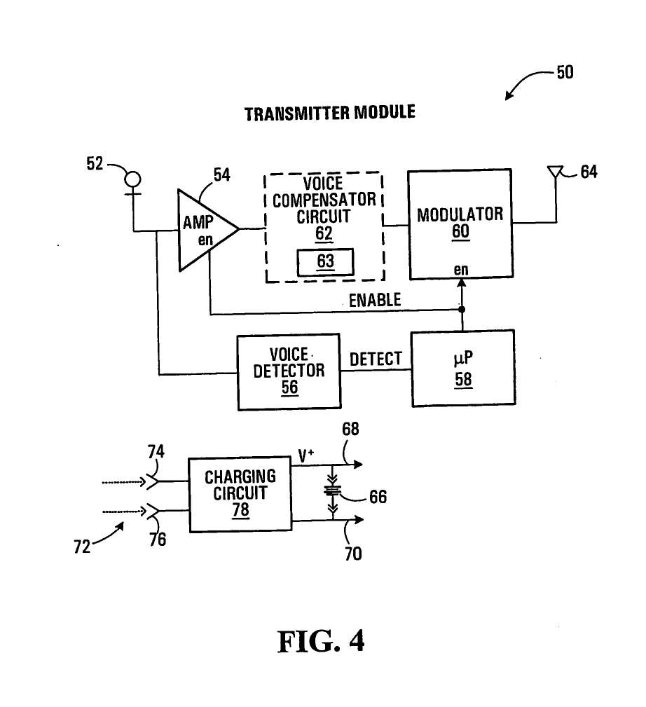

Referring to FIG. 4, a block diagram of the transmitter apparatus 14 is shown generally at 50. The transmitter apparatus 14 includes a microphone 52 that receives acoustic utterances made by a wearer of the breathing apparatus and produces electrical signals which are received by an amplifier 54. Electrical signals are also provided to a voice detection circuit 56 which supplies a detect signal to a microprocessor 58 which produces an enable signal that is provided to the amplifier 54 and to a modulator 60 in communication with the amplifier 54. Installation of the transmitter apparatus in the breathing apparatus reduces ambient noise in the vicinity of the wearer reaching the microphone 52 and thus false or unwanted activities of the voice detection circuit 56 are reduced.

In this embodiment, the amplifier 54 is in communication with the modulator 60 through a voice compensator 62 that compensates for distortions made to the acoustic utterances of the wearer of the breathing apparatus as a result of the cavity formed in the breathing apparatus between the wearer's face and the lens 18 and other components of the mask. Typically these distortions are manifest as amplified low frequencies and thus in this embodiment the voice compensator 62 includes a voice compensator circuit 63 which may include a filter circuit for attenuating low frequencies and boosting high frequencies. Thus, the voice compensator circuit 63 electrically compensates for distortions created in the breathing apparatus.

Alternatively, compensation for such distortions may be made by including mechanical components such as baffles and the like within the breathing apparatus.

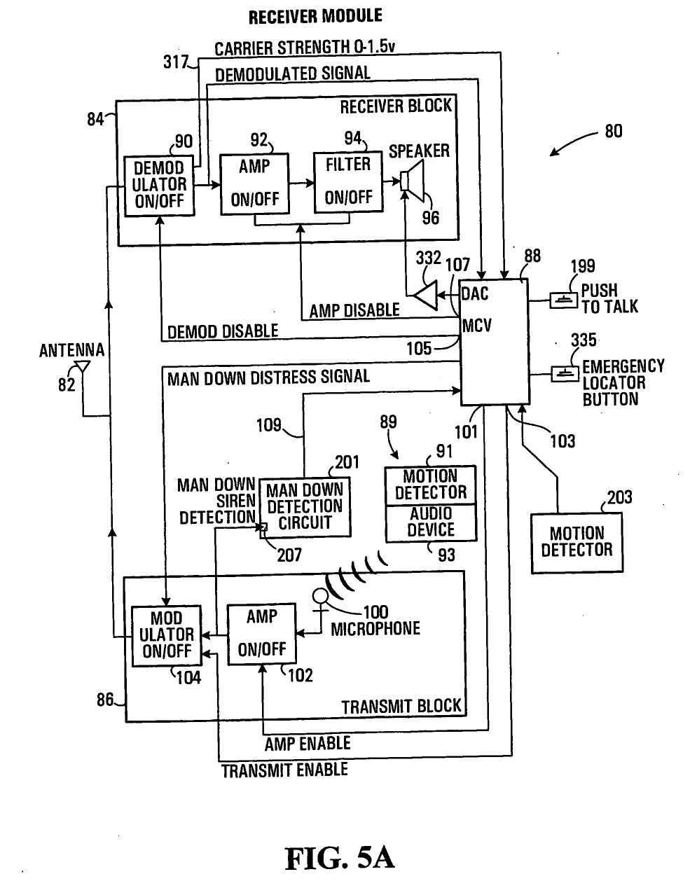

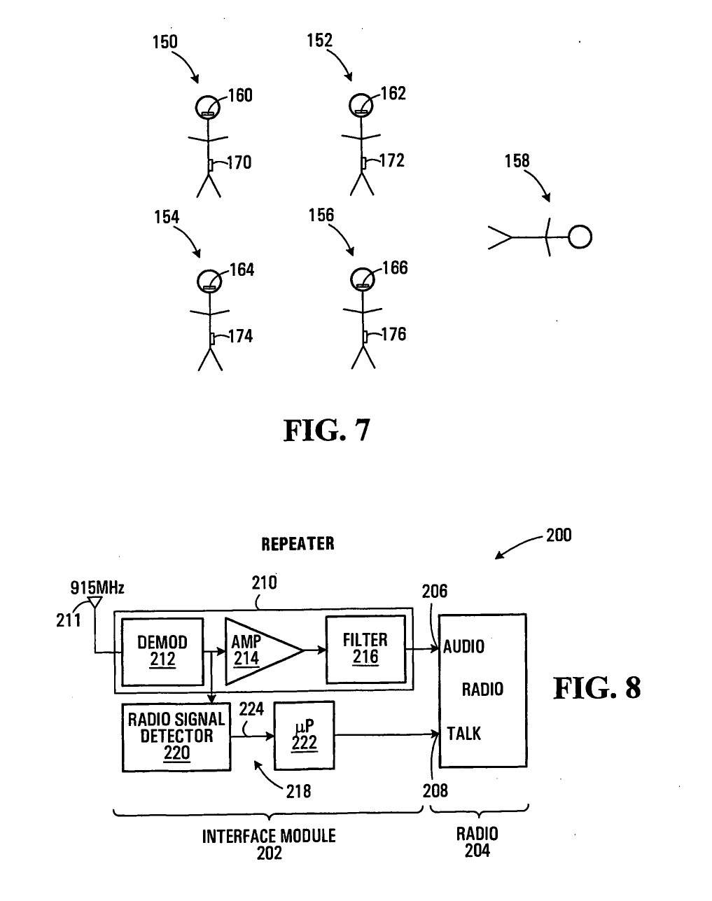

Still referring to FIG. 4, the modulator 60 provides a representation of the acoustic utterance modulated on a radio frequency carrier signal which is provided to an antenna 64 operable to radiate electromagnetic radiation representing the acoustic utterances, for reception by a receiver as shown in FIG. 5A and/or FIG. 8. In the embodiment shown, the electromagnetic radiation produced by the antenna is at a carrier frequency of approximately 915 MHz but could be produced at other carrier frequencies using known techniques.

Still referring to FIG. 4, in the embodiment shown the transmitter apparatus 14 further includes a rechargeable battery 66 for supplying power to power conductors 68 and 70 that distribute power to the amplifier 54, voice detection circuit 56, microprocessor 58, modulator 60 and voice compensator circuit 63, respectively.

The transmitter apparatus 14 also includes a power receptacle 72 having first and second power terminals 74 and 76 that are in communication with a charging circuit 78 which is connected to the battery 66. This enables an external device to supply power through the terminals 74 and 76 to the charging circuit 78 to recharge the battery 66. The charging circuit 78 may include a diode. Alternatively, non-rechargeable power sources such as alkaline batteries may be used and the charging circuit 78 may be disabled for use with such non-rechargeable sources.

Referring back to FIG. 2, in the embodiment shown the microphone 52 is situated on the first end portion 32 of the housing 30 and a charging port 55 is located on the opposite end portion 34 of the housing. The charging port 55 includes a charging socket 57. The terminals 74 and 76 shown in FIG. 4 are located within an opening in the charging socket 57, but within the housing.

Receiver

Referring to FIG. 5A, a receiver according to a first embodiment of the invention is shown generally at 80. The receiver includes an antenna 82, a receiver block shown generally at 84, and a transmitter block shown generally at 86. A processor circuit 88 controls components of the receiver block 84 and the transmitter block 86 such that generally only one of these blocks is active at any given time.

The receiver block 84 includes a demodulator 90 for demodulating signals received at the antenna 82 into baseband signals which are provided to an amplifier 92 which amplifies the baseband signals and provides them to a filter 94, which ultimately causes signals to be provided to a speaker 96. Thus, the electromagnetic radiation received from the transmitter apparatus shown in FIGS. 1, 2 or 3 is received at the antenna 82 of the receiver and demodulated so that a reproduction of the acoustic utterances originally detected by a transmitting transmitter apparatus 14 is broadcast on the speaker 96. This is the normal mode of operation and thus the speaker 96 continuously broadcasts a reproduction of the acoustic utterances in response to receipt of electromagnetic radiation from at least one of the transmitters.

The transmitter block 86 of the receiver includes a microphone 100, an amplifier 102 and a modulator 104. Referring to FIGS. 5A and 5B, when a push-to-talk switch 199 is actuated, the processor circuit 88, under the direction of a block 300 of codes, detects that the switch has been actuated. Block 302 then directs the processor circuit 88 to turn on the modulator 104 by activating an output 103 and to turn on the amplifier 102 by activating an output 101 and to turn off the receiver block by disabling the demodulator 90 and amplifier 92 by deactivating outputs 105 and 107, respectively. Block 303 directs the processor circuit 88 to maintain the current state of these devices until the push-to-talk switch 199 is no longer actuated. At that time, block 304 directs the processor circuit 88 to turn off the transmitter amplifier 102 and modulator 104 by deactivating outputs 101 and 103, respectively, and to activate the outputs 105 and 107 to turn on the demodulator 90 and the amplifier 92, respectively, to enable reception of radio signals.

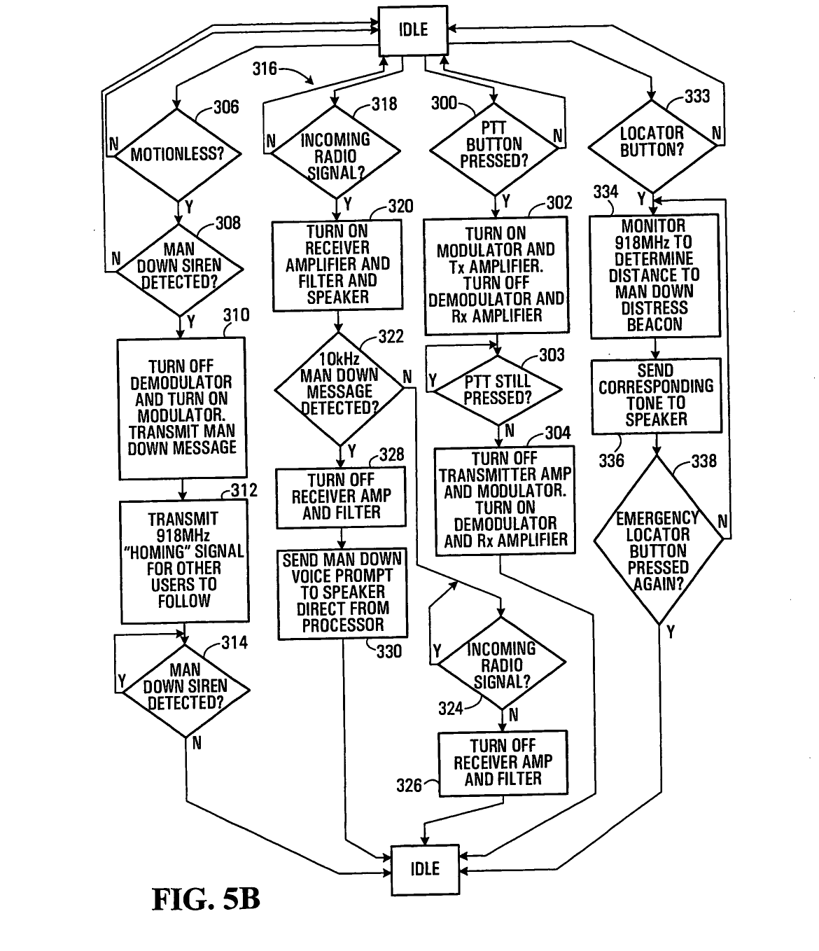

The processor circuit 88 is also controlled by blocks of code that direct the processor circuit to detect the occurrence of an event such as a “man down” condition. To do this, the receiver 80 is provided with a motion detector 203 and a block 306 of codes that causes the processor circuit 88 to monitor the motion detector to determine when there is no motion. When no motion is detected, the processor circuit 88 is set into a mode in which it listens for a pre-defined audio signal such as the audible signal produced by conventional “man down” sensing units as shown at 89 in FIG. 6A. These units include a detector 91 for detecting a “man down” event and an audio device 93 for emitting an audible siren sound in response to detection of the event. The apparatus 89 may be worn by a user, by employing a strap 95 or clip, for example, to secure the device to the user. Alternatively, the processor may be placed in a polling mode, periodically, for example, in which it enters the listening mode to listen for the predefined audio signal.

When the audible siren sound is detected by the processor circuit 88 a “man down” message is transmitted by the transmitter block of the receiver apparatus. The “man down” message may be a 10 kHz signal encoded on a 918 MHz carrier signal, for example. After the “man down” message is transmitted, a homing signal is transmitted. The homing signal may be useful in situations where the siren sound produced by the standard fire fighting equipment cannot be heard due to noise conditions or excessive distance, for example.

When the processor circuit 88 detects from the moton detector 203 that there is no motion, block 308 directs the processor circuit to enable the amplifier 102 by activating the output 101 while maintaining the modulator 104 disabled, to permit the audible siren sound to be received by the microphone 100, amplified by the amplifier 102, and provided to the “man down” detection circuit 201. The “man down” detection circuit 201 has a tone detector circuit 207 that produces a siren detect signal 109 for receipt by the processor circuit 88 to inform the processor circuit when the siren sound is received at the microphone 100. In this embodiment, the siren sound has a frequency of 1 kHz. Alternatively, the siren sound may have a frequency in a range of 1-4 kHz or any other suitable frequency or range of frequencies.

On detection of the siren sound, block 310 directs the processor circuit 88 to configure the output 105 to turn off the demodulator 90 and to configure the output 103 to turn on the modulator 104, while supplying the “man down” message to the modulator 104 so that a 918 MHz carrier frequency signal modulated with the “man down” message is transmitted by the antenna 82. In this embodiment, the “man down” message is a signal having a frequency of 10 kHz modulated on the 918 MHz carrier frequency. Alternatively, the “man down” message may have any other suitable frequency or range of frequencies. Block 312 then directs the processor circuit to transmit a continuous homing signal on the 918 MHz carrier to enable others to home in or locate the man wearing the receiver, i.e. the “man down”.

While the siren sound is detected, the processor circuit 88 continues to transmit the 918 MHz homing signal as indicated at block 314.

A process for receiving an incoming radio signal is shown generally at 316. The process begins with block 318 that directs the processor circuit 88 to receive signals from the demodulator 90. The demodulator 90 is normally in a receive mode in which it demodulates radio signals into baseband signals for reception by the amplifier 92 and by the processor circuit 88.

When a demodulated radio signal is received, a carrier strength signal 317 is produced and this signal is detected by block 318. Block 320 then directs the processor circuit 88 to turn on the amplifier 92, the filter 94 and the speaker 96. Block 322 then directs the processor circuit 88 to analyze the demodulated signal to determine whether it includes the “man down” message. If not, then block 324 directs the processor circuit 88 to maintain the amplifier 92, filter 94 and speaker 96 activated to permit the demodulated signal normally representing the acoustic utterances transmitted as electromagnetic radiation to be audibly reproduced by the speaker 96.

When no further radio signal is received, the processor is directed to block 326 which causes it to shut off the amplifier 92 and filter 94, with output 107, and speaker 96.

If at block 322, the “man down” message is detected, block 328 directs the processor circuit 88 to deactivate outputs 105 and 107 to turn off the receiver amplifier 92 and filter 94 and to proceed to block 330 which causes it to produce a synthesized voice signal, for example, as an analog signal, which is provided to a further amplifier 332 for amplification and communication to the speaker 96. The synthesized voice signal may utter “MAN DOWN”, for example.

Another function of the receiver 80 is to permit the user to actuate a locator function for locating and homing in on the 918 MHz homing signal mentioned above. To do this a block 333 of codes directs the processor circuit 88 to determine whether or not an emergency locator button 335 on the receiver 80 has been actuated. If it has, block 334 directs the processor circuit 88 to monitor the signal strength signal received from the demodulator 90 and block 336 directs the processor circuit 88 to produce a tone signal having a frequency dependent on signal strength and to send this tone to the speaker through the amplifier 332. This continues until the locator button is actuated again, in which case, as indicated at 338, the tone signal is no longer produced and applied to the speaker 96. The frequency of the tone signal may increase as the signal strength increases, for example.

The receiver shown in FIGS. 5A and 5B may be integrated into a housing having an appearance similar to that shown at 120 in FIG. 6B, for example. The speaker is shown generally at 96 and the talk button is shown at 106, for example. The unit shown is approximately the size of a walkie-talkie and may be supported by a person such as by use of a strap, for example, or by being clipped to the user's clothing such as on a belt, for example. Typically, the user supports the receiver 120 on his person.

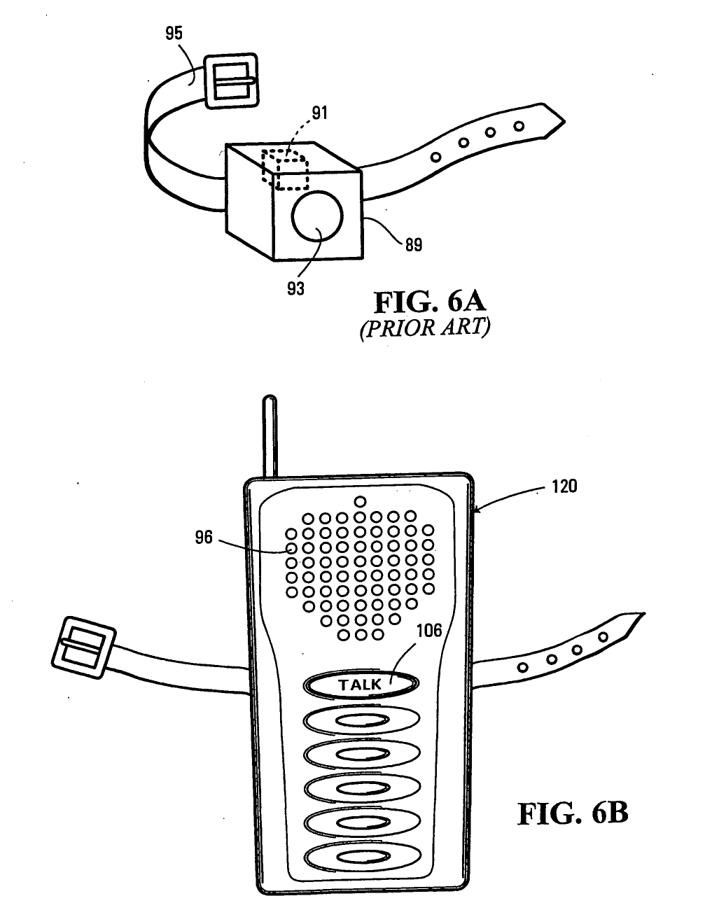

Referring to FIG. 7, a plurality of transmitters and receivers of the types described above may be employed to produce a system facilitating communications between wearers of a breathing apparatus and a listener within a range of at least one of the wearers of the breathing apparatus. More particularly, wearers of the breathing apparatus are shown at 150, 152, 154 and 156. These wearers may be fire fighters, for example. The listener is shown generally at 158 and may be an injured occupant of a building on fire.

The injured occupant may be awaiting rescue by one of the fire fighters 150 to 156. The fire fighters may also be listeners. Each of the fire fighters has his own transmitter apparatus 160, 162, 164 and 166, located in his breathing apparatus and each fire fighter has a receiver 170, 172, 174 and 176 supported on his person. When a fire fighter 150 to 156 is in relatively close proximity with another (approximately 200 feet, for example), utterances made by that fire fighter are transmitted as electromagnetic radiation by his respective transmitter apparatus and this electromagnetic radiation is received by each receiver operable to detect it. Each receiver that detects this electromagnetic radiation produces an audio signal that is audibly broadcast by the associated speaker in the receiver. In effect, each of the fire fighters 150 to 156 acts as a speaker holder, the speaker being in the receiver 170 to 176 and thus the system provides a simple mobile public address system over which any of the fire fighters 150 to 156 can broadcast a message. This mobile public address system allows any of the fire fighters to talk to the listener 158, if necessary, while at the same time allowing each of the remaining fire fighters to also listen to the communication. Consequently, the system provides a mobile public address system enabling communication between fire fighters while at the same time enabling communication between a fire fighter and a listener such as a “man down” or an incapacitated person.

Referring to FIG. 8, the system described above may further include a repeater as shown generally at 200 in FIG. 8. In this embodiment, the repeater 200 includes an interface module shown generally at 202 and a conventional radio such as a very high frequency (VHF) or ultra high frequency (UHF) radio 204 having audio and talk inputs 206 and 208, respectively. The audio input 206 is operable to receive an audio signal, whereas the talk input is operable to receive a digital signal representing whether or not the radio is to be put into a transmit or receive mode, the transmit mode being one in which a signal received at the audio input 206 is transmitted by the radio 204.

The interface module 202 includes a receiver 210 comprised of a demodulator 212, an amplifier 214 and a filter 216 for producing an audio signal operable to be received at the audio input 206 in response to electromagnetic radiation received at a carrier frequency of 915 MHz, for example, in this embodiment. The interface module 202 also includes a control circuit shown generally at 218 comprised of a radio signal detector 220 and a microprocessor 222. The radio signal detector 220 is operable to receive a signal from the demodulator 212 representing a demodulated version of the electromagnetic radiation received at an. antenna 211. The radio signal detector produces a digital signal at an output 224 representing whether or not a radio signal is detected, and the microprocessor 222 produces a digital signal compatible with the talk input 208, for controlling the radio 204 to cause the audio signal received at the input 206 to be transmitted on a VHF or UHF frequency. Thus, the interface module 202 effectively supplies a signal and controls the radio 204 to transmit the signal. In the embodiment shown, the audio signal supplied to the radio 204 is derived from electromagnetic radiation received at a carrier frequency of 915 MHz, for example, which includes radiation transmitted by any of the transmitter apparatuses 14 described above. Thus, the repeater 200 acts to receive electromagnetic radiation transmissions from the transmitters 160-166 located in the breathing apparatus 12, shown in FIGS. 1 and 3, to effectively cause audio signals representing utterances made by wearers of the breathing apparatus to be transmitted over conventional radio frequencies for reception by conventional radios. This allows fire fighters, for example, who are wearing the breathing apparatus to communicate with each other and to communicate to listeners in relatively close proximity, while allowing such communications to be retransmitted on conventional radio frequencies to permit conventional radio receivers to monitor such communications.

While specific embodiments of the invention have been described and illustrated, such embodiments are illustrative only and should not be construed as limiting the invention as defined by any claims that may be presented herein or in any corresponding patent application or patent.

1. A transmitter apparatus comprising:
a microphone operable to produce electrical signals representing acoustic utterances;
a transmitter circuit in communication with said microphone and operable to transmit electromagnetic radiation representing said acoustic utterances for reception by a receiver;
a housing having first and second opposite end portions and a retention portion between said first and second opposite end portions, said retention portion being operable to cooperate with a receptacle on a breathing apparatus to facilitate installation and removal of said transmitter apparatus on said breathing apparatus

2. The transmitter apparatus of claim 1 wherein said retention portion is operable to frictionally engage with said receptacle on said breathing apparatus.

3. The transmitter apparatus of claim 1 further comprising a compensator for compensating for distortions made to said acoustic utterances.

4. The transmitter apparatus of claim 3 wherein said compensator filters said acoustic utterances made by a wearer.

5. The transmitter apparatus of claim 3 wherein said compensator comprises a compensator circuit for electrically compensating for said distortions.

6. The apparatus of claim 1 wherein said microphone is on one of said first and second opposite end portions of said housing.

7. The apparatus of claim 1 further comprising power terminals for cooperating with a power source to permit said power source to provide energy for powering said transmitter apparatus.

8. The apparatus of claim 7 wherein said power terminals are inside said housing.

9. The apparatus of claim 7 further comprising a charging port for receiving energy supplied externally to said housing and for providing said energy to said power terminals.

10. The apparatus of claim 9 wherein said charging port comprises a charging socket on an end of said housing, opposite said end on which said microphone is located.

11. The apparatus of claim 1 wherein said retention portion is curved.

12. The apparatus of claim 1 wherein said retention portion is concave.

13. The apparatus of claim 1 wherein said retention portion has a leading edge and a trailing edge, said leading edge being thicker than said trailing edge.

14. The apparatus of claim 1 wherein said retention portion has a wedge-shaped cross section.

15. The apparatus of claim 1 wherein said housing is modular.

16. The apparatus of claim 1, further comprising a breathing apparatus having a receptacle for receiving and holding said housing therein.

17. A system comprising the apparatus of claim 1 and further comprising a receiver operable to be supported by a wearer of the breathing apparatus and operable to audibly broadcast a reproduction of said acoustic utterances in response to receipt of said electromagnetic radiation at said receiver.

18. The system of claim 17 wherein said receiver is operable to produce signals representing said acoustic utterances in response to said electromagnetic radiation and wherein said system further comprises a repeater operable to re-transmit said signals to a remote receiver.

19. A transmitter apparatus comprising:
means for producing electrical signals representing acoustic utterances;
means, in communication with said means for producing, for transmitting electromagnetic radiation representing said acoustic utterances for reception by a receiver;
means for housing said means for producing and said means for transmitting; and
means for retaining said means for housing in a receptacle on a breathing apparatus to facilitate installation of said transmitter apparatus into said breathing apparatus and to facilitate removal of the transmitter apparatus from said breathing apparatus.

20. A method of facilitating communications for a wearer of a breathing apparatus, the method comprising:
transmitting from a transmitter on the breathing apparatus electromagnetic radiation representing acoustic utterances made by the wearer of the breathing apparatus for reception by a receiver supported by the wearer; and
audibly broadcasting a reproduction of said acoustic utterances in response to receipt of said electromagnetic radiation at said receiver.

21. The method of claim 20 wherein transmitting comprises transmitting from said transmitter mounted on said breathing apparatus.

22. The method of claim 20 wherein transmitting comprises transmitting from a removable transmitter mounted in said breathing apparatus.

23. The method of claim 20 further comprising producing signals in response to said electromagnetic radiation and transmitting said signals to a repeater for re-transmission to a remote receiver.

24. The method of claim 20 further comprising producing electrical signals in response to said electromagnetic radiation, said electrical signals representing said acoustic utterances, and filtering said signals to correct for distortions.

25. An apparatus for facilitating communications for a wearer of a breathing apparatus, the apparatus comprising:
means on the breathing apparatus for transmitting electromagnetic radiation representing acoustic utterances made by the wearer of the breathing apparatus for reception by a receiver supported by the wearer; and
means for audibly broadcasting a reproduction of said acoustic utterances in response to receipt of said electromagnetic radiation at said receiver.

26. A method of facilitating communications between wearers of a breathing apparatus and a listener within a range of at least one of the wearers of the breathing apparatus, the method comprising:
transmitting from a transmitter on the breathing apparatus electromagnetic radiation representing acoustic utterances made by at least one wearer of a breathing apparatus, for reception by a plurality of receivers supported by respective wearers within a range; and
audibly broadcasting a reproduction of said acoustic utterances in response to receipt of said electromagnetic radiation at at least one of said receivers.

27. A system facilitating communications between wearers of a breathing apparatus and a listener within a range of at least one of the wearers of the breathing apparatus, the system comprising:
means for transmitting from a transmitter on the breathing apparatus electromagnetic radiation representing acoustic utterances made by at least one of the wearers of the breathing apparatus, for reception by a plurality of receivers supported by respective wearers within the range; and
means for audibly broadcasting a reproduction of said acoustic utterances in response to receipt of said electromagnetic radiation at at least one of said receivers.

28. A system facilitating communications between wearers of a breathing apparatus and a listener within a range of at least one of the wearers of the breathing apparatus, the system comprising:
a plurality of transmitters held in respective receptacles in respective breathing apparatuses for transmitting electromagnetic radiation representing acoustic utterances made by at least one of the wearers;
a plurality of receivers supported by respective wearers, for receiving said electromagnetic radiation representing said acoustic utterances from at least one of said transmitters; and
a plurality of speakers supported by said respective wearers, said speakers being controlled by respective said receivers to audibly broadcast a reproduction of said acoustic utterances represented by said electromagnetic radiation transmitted by at least one of said transmitters.

29. A method of communicating the occurrence of an event indicated by a pre-defined audio signal, the method comprising:
detecting a first pre-defined audio signal; and
transmitting a pre-defined radio frequency signal in response to detection of said first pre-defined audio signal.

30. The method of claim 29 further comprising wearing a detector capable of detecting said first pre-defined audio signal and wearing a transmitter capable of transmitting said pre-defined radio frequency signal.

31. The method of claim 29 wherein transmitting comprises transmitting a message indicative of the occurrence of said event.

32. The method of claim 29 wherein transmitting comprises transmitting a homing signal.

33. The method of claim 31 further comprising transmitting a homing signal.

34. The method of claim 29 further comprising detecting said event and producing said first pre-defined audio signal in response to detection of said event.

35. The method of claim 34 further comprising wearing a detector operable to detect said event.

36. The method of claim 29 further comprising producing a second pre-defined audio signal in response to receiving said first pre-defined radio frequency signal.

37. The method of claim 36 wherein producing said second pre-defined audio signal comprises producing a synthesized voice message.

38. An apparatus for communicating the occurrence of an event indicated by a pre-defined audio signal, the apparatus comprising:
means for detecting a first pre-defined audio signal; and
means for transmitting a pre-defined radio frequency signal in response to detection of said first pre-defined audio signal.

39. The apparatus of claim 38 further comprising means to facilitate wearing said means for detecting said first pre-defined audio signal and said means for transmitting.

40. The apparatus of claim 38 wherein said means for transmitting is operable to transmit a message indicative of said event.

41. The apparatus of claim 38 wherein said means for transmitting is operable to transmit a homing signal.

42. The apparatus of claim 40 wherein said means for transmitting is operable to transmit a homing signal.

43. A system comprising the apparatus of claim 38 and further comprising means for detecting said event and means for producing said first pre-defined audio signal in response to detection of said event.

44. The system of claim 43 further comprising means to facilitate wearing of said means for detecting said event.

45. A system comprising the apparatus of claim 38 and further comprising means for producing a second pre-defined audio signal in response to receiving said first pre-defined radio frequency signal.

46. The system of claim 45 wherein said means for producing said second pre-defined audio signal comprises means for producing a synthesized voice message.

47. An apparatus for communicating the occurrence of an event indicated by a pre-defined audio signal, the apparatus comprising:
a detector operable to detect a first pre-defined audio signal; and
a transmitter operable to transmit a pre-defined radio frequency signal in response to detection of said first pre-defined audio signal.

48. The apparatus of claim 47 further comprising a strap connected to said detector and said transmitter to facilitate wearing said detector and said transmitter on a person.

49. The apparatus of claim 47 wherein said transmitter is operable to transmit a message indicative of said event.

50. The apparatus of claim 47 wherein said transmitter is operable to transmit a homing signal.

51. The apparatus of claim 49 wherein said transmitter is operable to transmit a homing signal.

52. A system comprising the apparatus of claim 47 and further comprising an event detector and an audio signal generator in communication with said event detector for generating said first pre-defined audio signal in response to detection of said event.

53. The system of claim 52 further comprising a strap connected to said event detector and said audio signal generator to facilitate wearing said event detector and said audio signal generator on a person.

54. A system comprising the apparatus of claim 47 and further comprising a second audio signal generator for generating a second audio signal in response to receipt of said first pre-defined radio signal.

55. The system of claim 54 wherein said second audio signal generator comprises a voice synthesizer for producing a voice synthesized message.

56. A method of facilitating communications for a wearer of a mask, the method comprising:
receiving a removable transmitter apparatus in a receptacle in the mask, to permit said transmitter apparatus to receive utterances made by the wearer of the mask and to transmit electromagnetic radiation representing said utterances for reception by a receiver; and
frictionally engaging said removable transmitter apparatus in said receptacle to hold said removable transmitter apparatus therein.

57. The method of claim 56 wherein receiving said transmitter apparatus comprises receiving said transmitter apparatus in said receptacle on a user-facing side of said mask.

58. The method of claim 56 wherein receiving comprises receiving said transmitter apparatus between a breathing valve and a chin seal defining said receptacle in said mask.

59. The method of claim 58 wherein receiving further comprises receiving a portion of said chin seal between opposite end portions of said transmitter apparatus.

60. The method of claim 59 wherein receiving further comprises receiving a portion of said chin seal in a concave portion of said transmitter apparatus.

61. The method of claim 59 wherein receiving further comprises receiving a portion of said chin seal adjacent a curved portion of said transmitter.
